(19) United States
(12) Patent Application Publication
(10) Pub. No.: US 2019/0251263 A1
(43) Pub. Date: Aug. 15, 2019

(54) UNLOCKING MACHINE-READABLE STORAGE DEVICES USING A USER TOKEN

(71) Applicant: Hewlett-Packard Development Company, L.P., Spring, TX (US)

(72) Inventors: Taciano PEREZ, Porto Alegre (BR); Diego MEDAGLIA, Porto Alegre (BR); Thiago SILVA, Porto Alegre (BR); Carlos HAAS, Palo Alto, CA (US); Kimon BERLIN, Fort Collins, CO (US)

(73) Assignee: Hewlett-Packard Development Company, L.P., Spring, TX (US)

(21) Appl. No.: 16/316,583

(22) PCT Filed: Jul. 29, 2016
(86) PCT No.: PCT/US2016/044710

§ 371 Date: Jan. 9, 2019

(51) Int. Cl. G06F 21/57; G06F 21/62; H04L 9/32; H04L 29/06

(52) U.S. Cl. CPC G06F 21/572; H04L 63/062; H04L 9/3213; G06F 21/6218

(57) ABSTRACT

One example of a system includes a plurality of machine-readable storage devices, a machine-readable storage medium, and platform firmware. Each machine-readable storage device is to be unlocked for read and/or write access via a passphrase for each machine-readable storage device. The machine-readable storage medium stores an encrypted passphrase for each machine-readable storage device. The platform firmware is to receive a user token, derive a key from the user token, decrypt the encrypted passphrase stored in the machine-readable storage medium for each machine-readable storage device using the key, and unlock each machine-readable storage device using the decrypted passphrase for each machine-readable storage device.

### BACKGROUND

Passwords may be used to secure computer systems and individual devices within a computer system from unauthorized access. A user may be required to remember multiple passwords to access and use a computer system.

### BRIEF DESCRIPTION OF THE DRAWINGS

FIG. 1A is a block diagram illustrating one example of a system using local authentication for unlocking a plurality of machine-readable storage devices.

FIG. 1B is a block diagram illustrating one example of a system using remote authentication for unlocking a plurality of machine-readable storage devices.

FIG. 2 is a block diagram illustrating one example of a processing system for unlocking a plurality of machine-readable storage devices.

FIG. 3 is a flow diagram illustrating one example of a method for unlocking a plurality of machine-readable storage devices.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

In a computer system including multiple machine-readable storage devices (e.g., memory or storage devices such as non-volatile dual in-line memory modules (NV-DIMMs), hard disk drives (HDDs), solid state drives (SSDs), flash memory cards (e.g., secure digital (SD) cards) and the like), each machine-readable storage device may require a separate passphrase (e.g., password or other string of characters and/or numbers) to be unlocked for read and/or write access at boot time to enable normal operation. Remembering and providing multiple passphrases when booting a computer system, however, may be difficult and inconvenient for a user.

Accordingly, as described herein, platform firmware (e.g., basic input/output system (BIOS) or unified extensible firmware interface (UEFI)) is used to transparently and securely unlock a plurality of machine-readable storage devices for read and/or write access at boot time in response to receiving a single user token (e.g., password, passphrase, digital certificate, biometric token, etc.). The user token is used to derive a key, which is used to decrypt a passphrase for each of the plurality of machine-readable storage devices. The decrypted passphrase for each of the plurality of machine-readable storage devices is then used to unlock the corresponding machine-readable storage device. In this way, multiple machine-readable storage devices may be securely unlocked at boot time using a single user token.

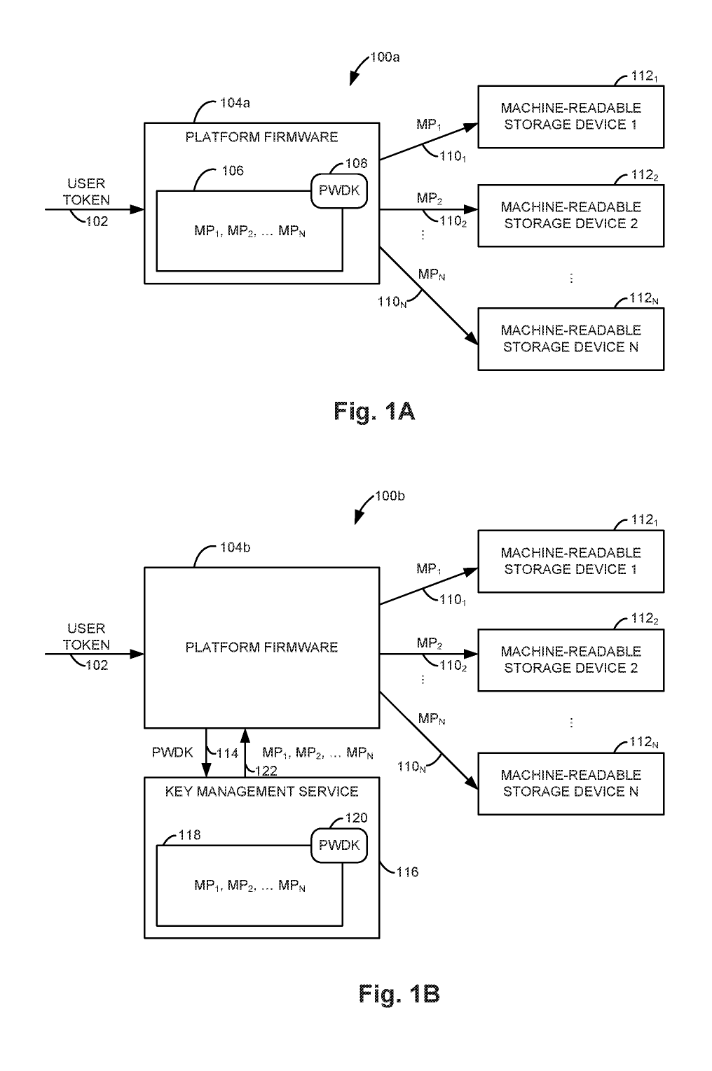

FIG. 1A is a block diagram illustrating one example of a system 100a using local authentication. System 100a includes platform firmware 104a and a plurality of machine-readable storage devices 112₁ to 112_{N}, where “N” is any suitable number of storage devices. Platform firmware 104a receives a user token on a communication path 102. Platform firmware 104a is communicatively coupled to each machine-readable storage device 112₁ to 112_{N} through a communication path 110₁ to 110_{N}, respectively. In one example, each machine-readable storage device 112₁ to 112_{N} is a NV-DIMM. In other examples, each machine-readable storage device 112₁ to 112_{N} is a HDD, a SSD, a flash memory card (e.g., a SD card), or another suitable memory or storage device.

Platform firmware 104a may be based on BIOS, UEFI, or another suitable platform firmware architecture used to perform hardware initialization at boot time of system 100a. Platform firmware 104a includes a machine-readable storage medium 106 (e.g., a platform firmware storage area) storing a plurality of encrypted passphrases MP₁ to MP_{N}. Each passphrase MP₁ to MP_{N} corresponds to a machine-readable storage device 112₁ to 112_{N}, respectively. Machine-readable storage medium 106 may also store identifying information (e.g., serial numbers) for each machine-readable storage device 112₁ to 112_{N} associated with the encrypted passphrase for each machine-readable storage device 112₁ to 112_{N}, respectively, so that each passphrase may be reconciled with their respective device. In one example, each passphrase MP₁ to MP_{N} is encrypted using a key PWDK as indicated at 108 using symmetric encryption. In another example, each passphrase MP₁ to MP_{N} is encrypted using a public encryption key using asymmetric encryption. In this case, the private decryption key is encrypted using key PWDK 108 and stored in machine-readable storage medium 106. In either case, key PWDK 108 is not stored in machine-readable storage medium 106, but rather derived from the user token received on communication path 102.

At boot time, platform firmware 104a requests the user to provide their user token (e.g., password, passphrase, digital certificate, biometric token such as a fingerprint, etc.). At other times, such as on resumes from suspend and/or hibernate, platform firmware 104a may or may not request the user to again provide their user token depending on the configuration of platform firmware 104a. Using the user token, platform firmware 104a derives a key. In one example, platform firmware 104a derives the key by using a hash function. In other examples, any suitable method may be used to derive the key from the user token.

In response to a valid user token being provided and therefrom a valid key being derived (i.e., the derived key provides key PWDK 108), platform firmware 104a decrypts the encrypted passphrases MP₁ to MP_{N} stored in machine-readable storage medium 106 directly using key PWDK 108 (i.e., for symmetric encryption) or decrypts the encrypted private decryption key using key PWDK 108 and then decrypts the encrypted passphrases MP₁ to MP_{N} using the private decryption key (i.e., for asymmetric encryption). In response to an invalid user token being provided and therefrom an invalid key being derived (i.e., the derived key does not provide key PWDK 108), platform firmware 104a will be unable to decrypt the encrypted passphrases MP₁ to MP_{N}.

Once platform firmware 104a decrypts the encrypted passphrases MP₁ to MP_{N}, platform firmware 104a transmits each decrypted passphrase MP₁ to MP_{N} to the corresponding machine-readable storage device 112₁ to 112_{N} through communication paths 110₁ to 110_{N}, respectively. In response to receiving a valid passphrase, each machine-readable storage device 112₁ to 112_{N} is unlocked for read and/or write access. In one example, the same user token is used to unlock machine-readable storage devices 112₁ to 112_{N} and an operating system of system 100a at boot time.

In one example when using symmetric encryption, machine-readable storage medium 106 may store a plurality of encrypted passphrases for each machine-readable storage device 112₁ to 112_{N}, respectively. In this example, each of the plurality of encrypted passphrases for each machine-readable storage device 112₁ to 112_{N} corresponds to a different user token. Each valid user token is used to derive a corresponding key to decrypt the corresponding encrypted passphrases. In another example when using asymmetric encryption, multiple users may have access to the private decryption key by storing a different copy of the private decryption key in machine-readable storage medium 106 for each user, with each user's private decryption key encrypted with a different key PWDK 108 derived from the user's token. Therefore, platform firmware 104a may unlock machine-readable storage devices 112₁ to 112_{N} for read and/or write access by receiving any one of a plurality of valid user tokens.

FIG. 1B is a block diagram illustrating one example of a system 100b using remote authentication. System 100b includes platform firmware 104b, plurality of machine-readable storage devices 112₁ to 112_{N}, and a key management service 116. Platform firmware 104b receives a user token on a communication path 102. Platform firmware 104b is communicatively coupled to each machine-readable storage device 112₁ to 112_{N} through a communication path 110₁ to 110_{N}, respectively. Platform firmware 104b is communicatively coupled to key management service 116 through a secure channel including a key PWDK communication path 114 and a passphrase communication path 122. In one example, the secure channel is over a network connection, such as the Internet or an intranet.

Platform firmware 104b may be based on BIOS, UEFI, or another suitable platform firmware architecture used to perform hardware initialization at boot time of system 100b. Key management service 116 includes a machine-readable storage medium 118 storing a plurality of encrypted passphrases MP₁ to MP_{N}. Each passphrase MP₁ to MP_{N} corresponds to a machine-readable storage device 112₁ to 112_{N}, respectively. Machine-readable storage medium 118 may also store identifying information (e.g., serial numbers) for each machine-readable storage device 112₁ to 112_{N} associated with the encrypted passphrase for each machine-readable storage device 112₁ to 112_{N}, respectively, so that each passphrase may be reconciled with their respective device. In one example, each passphrase MP₁ to MP_{N} is encrypted using a key PWDK as indicated at 120 using symmetric encryption. In another example, each passphrase MP₁ to MP_{N} is encrypted using a public encryption key using asymmetric encryption. In this case, the private decryption key is encrypted using key PWDK 120 and stored in machine-readable storage medium 118. In either case, key PWDK 120 is not stored in machine-readable storage medium 118, but rather derived from the user token received on communication path 102.

At boot time, platform firmware 104b requests the user to provide their user token (e.g., password, passphrase, digital certificate, biometric token such as fingerprint, etc.). At other times, such as on resumes from suspend and/or hibernate, platform firmware 104b may or may not request the user to again provide their user token depending on the configuration of platform firmware 104b. In one example, using the user token, platform firmware 104b derives a key and transmits the key to key management service 116 through communication path 114. In another example, platform firmware 104b transmits the user token to key management service 116 through communication path 114 and key management service 116 derives a key. Platform firmware 104b or key management service 116 may derive the key by using a hash function. In other examples, any suitable method may be used to derive the key from the user token.

In response to a valid user token being provided and therefrom a valid key being derived (i.e., the derived key provides key PWDK 120), in one example, key management service 116 decrypts the encrypted passphrases MP₁ to MP_{N} stored in machine-readable storage medium 118 directly using key PWDK 120 (i.e., for symmetric encryption) or decrypts the encrypted private decryption key using key PWDK 120 and then decrypts the encrypted passphrases MP₁ to MP_{N} using the private decryption key (i.e., for asymmetric encryption). Key management service 116 then transmits the decrypted passphrases MP₁ to MP_{N} to platform firmware 104b through communication path 122. In another example, key management service 116 transmits the encrypted passphrases MP₁ to MP_{N} to platform firmware 104b through communication path 122 and platform firmware 104b decrypts the encrypted passphrases MP₁ to MP_{N} using key PWDK 120. In response to an invalid user token being provided and therefrom an invalid key being derived (i.e., the derived key does not provide key PWDK 120), platform firmware 104b and/or key management service 116 will be unable to decrypt the encrypted passphrases MP₁ to MP_{N}.

Once platform firmware 104b or key management service 116 decrypts the encrypted passphrases MP₁ to MP_{N}, platform firmware 104b transmits each decrypted passphrase MP₁ to MP_{N} to the corresponding machine-readable storage device 112₁ to 112_{N} through communication paths 110₁ to 110_{N}, respectively. In response to receiving a valid passphrase, each machine-readable storage device 112₁ to 112_{N} is unlocked for read and/or write access. In one example, the same user token is used to unlock machine-readable storage devices 112₁ to 112_{N} and an operating system of system 100b at boot time.

In one example when using symmetric encryption, machine-readable storage medium 118 may store a plurality of encrypted passphrases for each machine-readable storage device 112₁ to 112_{N}, respectively. In this example, each of the plurality of encrypted passphrases for each machine-readable storage device 112₁ to 112_{N} corresponds to a different user token. Each valid user token is used to derive a corresponding key to decrypt the corresponding encrypted passphrases. In another example when using asymmetric encryption, multiple users may have access to the private decryption key by storing a different copy of the private decryption key in machine-readable storage medium 118 for each user, with each user's private decryption key encrypted with a different key PWDK 120 derived from the user's token. Therefore, platform firmware 104b may unlock machine-readable storage devices 112₁ to 112_{N} for read and/or write access by receiving any one of a plurality of valid user tokens.

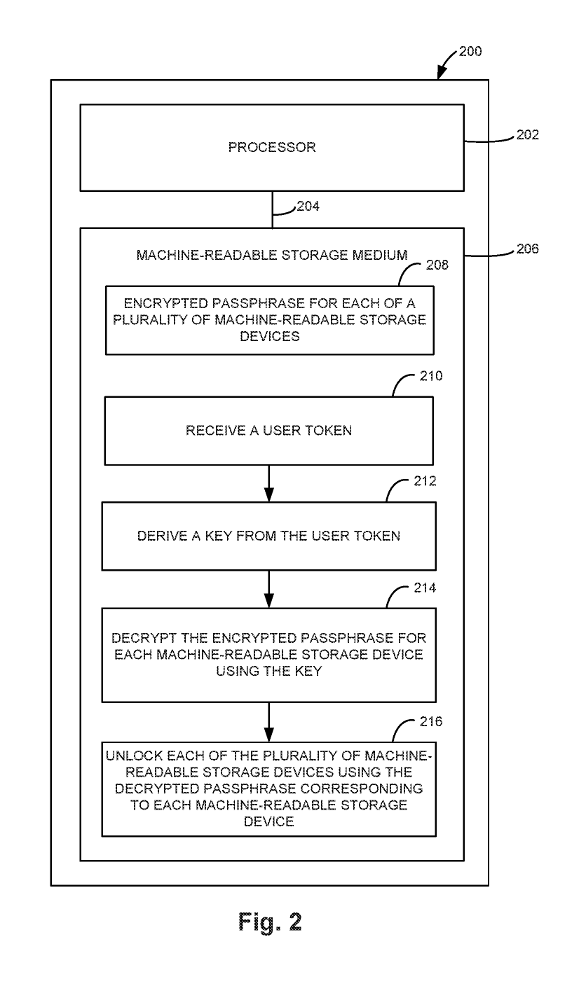

FIG. 2 is a block diagram illustrating one example of a processing system 200. System 200 includes a processor 202 and a machine-readable storage medium 206. Processor 202 is communicatively coupled to machine-readable storage medium 206 through a communication path 204. Although the following description refers to a single processor and a single machine-readable storage medium, the description may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 202 includes one or more central processing units (CPUs), microprocessors, and/or other suitable hardware devices for retrieval and execution of instructions stored in machine-readable storage medium 206. Machine-readable storage medium 206 may store data 208 including an encrypted passphrase for each of a plurality of machine-readable storage devices, such as machine-readable storage devices 112₁ to 112_{N} previously described and illustrated with reference to FIG. 1A. In one example, machine-readable storage medium 206 stores identifying information for each machine-readable storage device associated with the encrypted passphrase for each machine-readable storage device. In another example, the encrypted passphrase for each of the plurality of machine-readable storage devices may be stored in a machine-readable storage medium of a key management service, such as key management service 116 previously described and illustrated with reference to FIG. 1B.

Processor 202 may fetch, decode, and execute instructions 210-216 to unlock the plurality of machine-readable storage devices. Processor 202 may fetch, decode, and execute instructions 210 to receive a user token. In one example, the user token includes a password, a passphrase, a digital certificate, or a biometric token. Processor 202 may fetch, decode, and execute instructions 212 to derive a key from the user token. In one example, the key may be derived from the user token by using a hash function. Processor 202 may fetch, decode, and execute instructions 214 to decrypt the encrypted passphrase for each machine-readable storage device using the key. Processor 202 may fetch, decode, and execute instructions 216 to unlock each of the plurality of machine-readable storage devices using the decrypted passphrase corresponding to each machine-readable storage device. In one example, each machine-readable storage device includes a NV-DIMM, a HDD, a SSD, or a flash memory card.

As an alternative or in addition to retrieving and executing instructions, processor 202 may include one or more electronic circuits comprising a number of electronic components for performing the functionality of one or more of the instructions in machine-readable storage medium 206. With respect to the executable instruction representations (e.g., boxes) described and illustrated herein, it should be understood that part or all of the executable instructions and/or electronic circuits included within one box may, in alternate examples, be included in a different box illustrated in the figures or in a different box not shown.

Machine-readable storage medium 206 is a non-transitory storage medium and may be any suitable electronic, magnetic, optical, or other physical storage device that stores executable instructions. Thus, machine-readable storage medium 206 may be, for example, random access memory (RAM), an electrically-erasable programmable read-only memory (EEPROM), a storage drive, an optical disc, and the like. Machine-readable storage medium 206 may be disposed within system 200, as illustrated in FIG. 2. In this case, the executable instructions may be installed on system 200. Alternatively, machine-readable storage medium 206 may be a portable, external, or remote storage medium that allows system 200 to download the instructions from the portable/external/remote storage medium. In this case, the executable instructions may be part of an installation package.

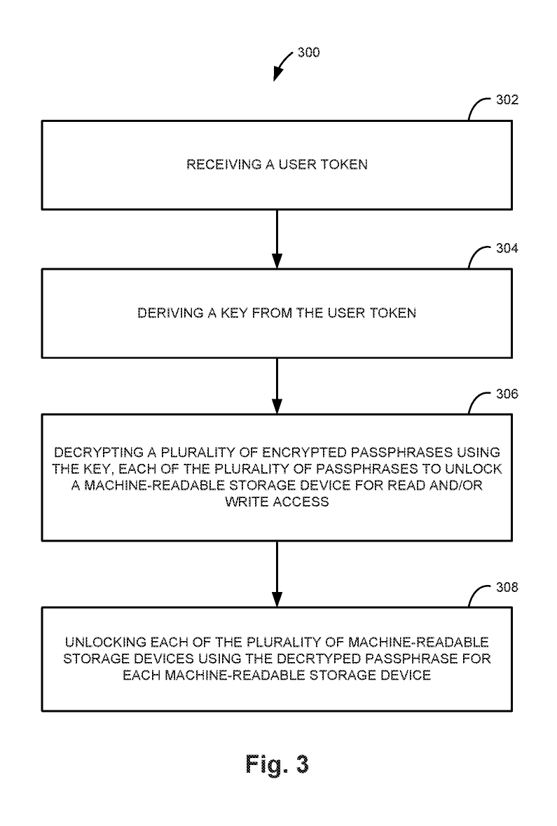

FIG. 3 is a flow diagram illustrating one example of a method 300 for unlocking a plurality of machine-readable storage devices. At 302, method 300 includes receiving a user token. At 304, method 300 includes deriving a key from the user token. In one example, deriving the key from the user token includes deriving the key using a hash function. At 306, method 300 includes decrypting a plurality of encrypted passphrases using the key, each of the plurality of passphrases to unlock a machine-readable storage device for read and/or write access. In one example, decrypting the plurality of encrypted passphrases includes transmitting the key to a key management service and receiving the plurality of decrypted passphrases from the key management service. At 308, method 300 includes unlocking each of the plurality of machine-readable storage devices using the decrypted passphrase for each machine-readable storage device.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A system comprising:
a plurality of machine-readable storage devices, each machine-readable storage device to be unlocked for read and/or write access via a passphrase for each machine-readable storage device;
a machine-readable storage medium storing an encrypted passphrase for each machine-readable storage device; and
platform firmware to receive a user token, derive a key from the user token, decrypt the encrypted passphrase stored in the machine-readable storage medium for each machine-readable storage device using the key, and unlock each machine-readable storage device using the decrypted passphrase for each machine-readable storage device.

2. The system of claim 1, wherein the platform firmware comprises the machine-readable storage medium.

3. The system of claim 1, further comprising:
a key management service comprising the machine-readable storage medium,
wherein the platform firmware is to transmit the key to the key management service and in response the key management service is to transmit the decrypted passphrase for each machine-readable storage device to the platform firmware.

4. The system of claim 1, wherein the platform firmware comprises a basic input/output system (BIOS) or unified extensible firmware interface (UEFI).

5. The system of claim 1, wherein each machine-readable storage device comprises a non-volatile dual in-line memory module (NV-DIMM).

6. The system of claim 1, wherein each encrypted passphrase is encrypted using symmetric encryption or asymmetric encryption, and
wherein the platform firmware decrypts a private decryption key using the key and decrypts the encrypted passphrases using the private decryption key when each encrypted passphrase is encrypted using asymmetric encryption.

7. The system of claim 1, wherein the machine-readable storage medium stores a plurality of encrypted passphrases for each machine-readable storage device, each of the plurality of encrypted passphrases for each machine-readable storage device corresponding to a different user token.

8. The system of claim 1, wherein the user token unlocks an operating system at boot time.

9. A system comprising:
a machine-readable storage medium storing instructions and an encrypted passphrase for each of a plurality of machine-readable storage devices; and
a processor to execute the instructions to:
receive a user token;
derive a key from the user token;
decrypt the encrypted passphrase for each machine-readable storage device using the key; and
unlock each of the plurality of machine-readable storage devices using the decrypted passphrase corresponding to each machine-readable storage device.

10. The system of claim 9, wherein the machine-readable storage medium stores identifying information for each machine-readable storage device associated with the encrypted passphrase for each machine-readable storage device.

11. The system of claim 9, wherein the user token comprises a password, a passphrase, a digital certificate, or a biometric token.

12. The system of claim 9, wherein each machine-readable storage device comprises a non-volatile dual in-line memory module (NV-DIMM), a hard disk drive, a solid state drive, or a flash memory card.

13. A method to unlock a plurality of machine-readable storage devices, the method comprising:
receiving a user token;
deriving a key from the user token;
decrypting a plurality of encrypted passphrases using the key, each of the plurality of passphrases to unlock a machine-readable storage device for read and/or write access; and
unlocking each of the plurality of machine-readable storage devices using the decrypted passphrase for each machine-readable storage device.

14. The method of claim 13, wherein decrypting the plurality of encrypted passphrases comprises:
transmitting the key to a key management service; and
receiving the plurality of decrypted passphrases from the key management service.

15. The method of claim 13, wherein deriving the key from the user token comprises deriving the key using a hash function.
